(19) United States
(12) Patent Application Publication
(10) Pub. No.: US 2009/0072664 A1
(43) Pub. Date: Mar. 19, 2009

(54) DRIVING APPARATUS

(76) Inventors: Kazuaki NAGATA, Saitama-shi (JP); Mitsuo Manabe, Saitama-shi (JP)

Correspondence Address: BIRCH STEWART KOLASCH & BIRCH, PO BOX 747, FALLS CHURCH, VA, 22040-0747, US

(21) Appl. No.: 12/208,169

(22) Filed: Sep. 10, 2008

(30) Foreign Application Priority Data
Sep. 14, 2007 (JP) P2007-239902
Mar. 28, 2008 (JP) P2008-087136

(51) Int. Cl. H02N 2/08

(52) U.S. Cl. 310/323.02

(57) ABSTRACT

A driving apparatus comprises: an electromechanical conversion element that expands or contracts along an expanding and contracting direction; a driving member attached to one end of the electromechanical conversion element in the expanding and contracting direction; a driven body frictionally engaged with the driving member; and a printed circuit board that transmits an electrical signal for driving the electromechanical conversion element, wherein the electromechanical conversion element is mounted on a surface of the printed circuit board such that the expanding and contracting direction becomes substantially parallel to the surface of the printed circuit board, and the electromechanical conversion element is electrically connected to the printed circuit board.

### BACKGROUND OF THE INVENTION

1. Field of the Invention

The present invention relates to a driving apparatus suitable for driving a lens or the like in such as a cellular telephone with a camera, a compact digital camera, and the like.

2. Description of the Related Art

As the related-art driving apparatuses in the above-described technical field, JP-A-2007-274777 and JP-A-2006-311794 describe driving apparatuses including an electromechanical conversion element which expands or contracts along an expanding and contracting direction; a driving member attached to one end of the electromechanical conversion element in the expanding and contracting direction; a driven body which is frictionally engaged with the driving member; and a printed circuit board, such as a flexible printed circuit board, to which the electromechanical conversion element is electrically connected by means of solder, an electrically conductive adhesive, or the like.

In addition, JP-A-2007-74889 describes a driving apparatus including an electromechanical conversion element which expands or contracts along an expanding and contracting direction; a driving member attached to one end of the electromechanical conversion element in the expanding and contracting direction; a driven body which is frictionally engaged with the driving member; and a support for supporting the electromechanical conversion element.

In these driving apparatuses, as driving pulses having a sawtooth waveform are applied to the electromechanical conversion element, the electromechanical conversion element is deformed in a state in which an expansion speed and a contraction speed are different. Then, when the electromechanical conversion element is deformed at a slow speed, the driven body becomes stationary with respect to the driving member due to friction, whereas when the electromechanical conversion element is deformed at a fast speed, the driven body moves with respect to the driving member due to inertia. Accordingly, as the driving pulses having the sawtooth waveform are repeatedly applied to the electromechanical conversion element, it is possible to move the driven body intermittently at fine pitches.

However, in the driving apparatuses of JP-A-2007-274777 and JP-A-2006-311794, since the electromechanical conversion element is mounted on the printed circuit board such that the expanding and contracting direction of the electromechanical conversion element becomes substantially perpendicular to a surface of the printed circuit, there is a problem in that the adoption of a low profile of the driving apparatus in the substantially perpendicular direction to the expanding and contracting direction of the electromechanical conversion element is prevented.

Such a problem also holds true of the driving apparatus described in JP-A-2007-74889 since an electrical signal for driving the electromechanical conversion element is generally transmitted by electrically connecting lead wires to the electromechanical conversion element.

It should be noted that, in JP-A-2007-74889, since an electrical signal for driving the electromechanical conversion element is generally transmitted by electrically connecting lead wires to the electromechanical conversion element, the following problem can also possibly occur. Namely, at the time of the assembly of the driving apparatus, since the forming of the lead wires is effected after the electromechanical conversion element is fixed to the support, there is a possibility that stress may be concentrated at a connecting portion between the electromechanical conversion element and the lead wires and the connecting portion may become damaged, with the result that it becomes impossible to reliably transmit the electrical signal to the electromechanical conversion element.

### SUMMARY OF THE INVENTION

Accordingly, the present invention has been devised in view of the above-described circumstances, and its object is to provide a driving apparatus which makes it possible to lower the profile of the driving apparatus in the substantially perpendicular direction to the expanding and contracting direction of the electromechanical conversion element.

To attain the above object, in accordance with one aspect of the invention there is provided a driving apparatus comprising: an electromechanical conversion element that expands or contracts along an expanding and contracting direction; a driving member attached to one end of the electromechanical conversion element in the expanding and contracting direction; a driven body frictionally engaged with the driving member; and a printed circuit board that transmits an electrical signal for driving the electromechanical conversion element, wherein the electromechanical conversion element is mounted on a surface of the printed circuit board such that the expanding and contracting direction becomes substantially parallel to the surface of the printed circuit board, and the electromechanical conversion element is electrically connected to the printed circuit board.

In this driving apparatus, the electromechanical conversion element is mounted on the surface of the printed circuit board such that the expanding and contracting direction of the electromechanical conversion element becomes substantially parallel to the surface of the printed circuit board, and the electromechanical conversion element is electrically connected to the printed circuit board. As a result, the thicknesswise direction of the printed circuit board coincides with the substantially perpendicular direction to the expanding and contracting direction of the electromechanical conversion element, so that it is possible to attain a low profile of the driving apparatus in that direction.

In addition, in the driving apparatus in accordance with the invention, in a portion where the electromechanical conversion element is mounted, the printed circuit board in the expanding and contracting direction has a length equal to or shorter than that of the electromechanical conversion element in the expanding and contracting direction. In this case, the attachment of the driving member to one end of the electromechanical conversion element and the attachment of such as a weight to the other end of the electromechanical conversion element are prevented from being hampered by the printed circuit board.

In the driving apparatus in accordance with the invention, the printed circuit board is preferably a flexible printed circuit board. By using a flexible printed circuit board as the printed circuit board, it is possible to enlarge the degree of freedom in the wiring layout.

In the driving apparatus in accordance with the invention, the electromechanical conversion element is preferably electrically connected to the printed circuit board by an electrically conductive adhesive. By using an electrically conductive adhesive which has lower rigidity and higher elasticity than solder, it is possible to prevent the expansion and contraction of the electromechanical conversion element from being hampered due to the electrical connection to the printed circuit board.

In addition, the electromechanical conversion element is preferably supported, at its portion opposite to its portion where the printed circuit board is mounted, by an elastic member from a lateral direction with respect to the expanding and contracting direction. According to this configuration, the vibration due to the expansion and contraction of the electromechanical conversion element becomes difficult to be transmitted to the elastic member. As a result, the driven body can be reliably moved relative to the driving member while preventing the effect of resonance accompanying the expansion and contraction of the electromechanical conversion element.

In addition, in accordance with another aspect of the invention, there is provided a driving apparatus comprising: an electromechanical conversion element that expands or contracts along an expanding and contracting direction; a driving member attached to one end of the electromechanical conversion element in the expanding and contracting direction; a driven body frictionally engaged with the driving member; and a printed circuit board to which the electromechanical conversion element is electrically connected by an electrically conductive adhesive, and which transmits an electrical signal for driving the electromechanical conversion element; and a support that supports the electromechanical conversion element, wherein the printed circuit board is fixed to the support so that the support supports the electromechanical conversion element.

In this driving apparatus, the printed circuit board, to which the electromechanical conversion element is electrically connected by the electrically conductive adhesive, is used for the transmission of electrical signals for driving the electromechanical conversion element. For this reason, the thicknesswise direction of the printed circuit board can be made to coincide with the substantially perpendicular direction to the expanding and contracting direction of the electromechanical conversion element, thereby making it possible to lower the profile of the driving apparatus in that direction. Furthermore, as the printed circuit board is fixed to the support, the support supports the electromechanical conversion element. Consequently, at the time of the assembly of the driving apparatus, the concentration of stress at a connecting portion between the electromechanical conversion element and the printed circuit board is avoided, so that it is possible to reliably transmit the electrical signals to the electromechanical conversion element through the printed circuit board.

In the driving apparatus in accordance with the invention, preferably, the printed circuit board is a flexible printed circuit board and is fixed to the support by means of a reinforcing member. By using a flexible printed circuit board as the printed circuit board, it is possible to enlarge the degree of freedom in the wiring layout. Moreover, since the flexible printed circuit board is fixed to the support by means of a reinforcing member, it is possible to prevent the flexible printed circuit board from becoming deformed to damage the connecting portion between the electromechanical conversion element and the flexible printed circuit board.

### BRIEF DESCRIPTION OF THE DRAWINGS

FIG. 1 is a cross-sectional view of a first embodiment of a driving apparatus in accordance with the invention;

FIG. 2 is a cross-sectional view taken along line II-II of FIG. 1;

FIG. 3 is a cross-sectional view taken along line III-III of FIG. 1;

FIG. 4 is a perspective view of a piezoelectric element and its vicinities of the driving apparatus shown in FIG. 1;

FIG. 5 is a cross-sectional view of a second embodiment of the driving apparatus in accordance with the invention;

FIG. 6 is a cross-sectional view taken along line VI-VI of FIG. 5;

FIG. 7 is a cross-sectional view taken along line VII-VII of FIG. 5;

FIG. 8 is a cross-sectional view taken along line VIII-VIII of FIG. 5;

FIG. 9 is a perspective view of a piezoelectric element unit and its vicinities of the driving apparatus shown in FIG. 5;

FIG. 10 is a front elevational view of the piezoelectric element unit and its vicinities of the driving apparatus shown in FIG. 5;

FIG. 11 is a circuit diagram of a driving circuit for operating the piezoelectric element of the driving apparatus shown in FIG. 5;

FIGS. 12A and 12B are waveform diagrams of input signals which are inputted to the driving circuit shown in FIG. 11;

FIGS. 13A and 13B are waveform diagrams of output signals which are outputted from the driving circuit shown in FIG. 11;

FIG. 14 is a front elevational view of the piezoelectric element unit and its vicinities of the driving apparatus in accordance with a modification; and

FIG. 15 is a cross-sectional view of the piezoelectric element unit and its vicinities of the driving apparatus in accordance with the modification.

### DETAILED DESCRIPTION OF THE INVENTION

Hereafter, a detailed description will be given of the preferred embodiments of the invention with reference to the accompanying drawings. It should be noted that in the drawings identical or corresponding portions will be denoted by identical reference numerals, and an overlapping description will be omitted.

### First Embodiment

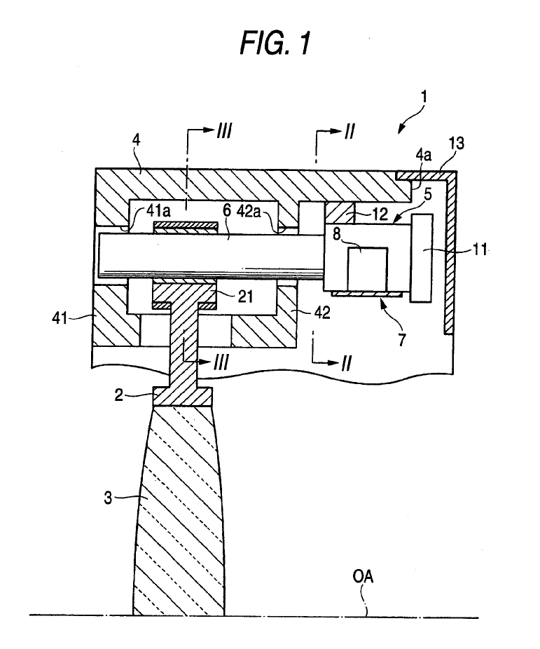

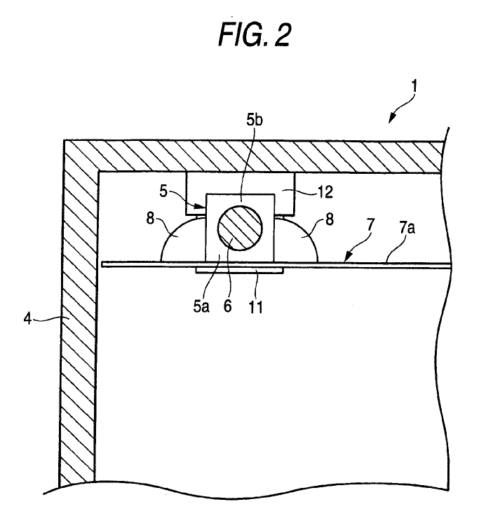

FIG. 1 is a cross-sectional view of a first embodiment of the driving apparatus in accordance with the invention, and FIG. 2 is a cross-sectional view taken along line II-II of FIG. 1. As shown in FIGS. 1 and 2, a driving apparatus 1 is an apparatus for driving a lens 3, which is held by a lens frame (driven body) 2, along an optical axis OA, and is suitable for use in a cellular telephone with a camera, a compact digital camera, or the like. The driving apparatus 1 has, within a holder 4 constituting an outer periphery of the driving apparatus 1, a piezoelectric element (electromechanical conversion element) 5, a driving shaft (driving member) 6, a flexible printed circuit board (FPC) 7, and a weight 11.

The piezoelectric element 5 expands and contracts along an expanding and contracting direction parallel to the optical axis. OA (hereafter, this direction will be simply referred to as the “expanding and contracting direction”). In the piezoelectric element 5, its portion 5b opposite to a portion 5a having the FPC 7 mounted thereon is clamped by an elastic member 12 formed of, for example, silicone, and this elastic member 12 is fixed to the holder 4. As a result, the piezoelectric element 5 at its portion 5b opposite to the portion 5a having the FPC 7 mounted thereon is elastically supported by the elastic member 12 from lateral directions with respect to the expanding and contracting direction. The driving shaft 6 extends along the expanding and contracting direction and is fixed to one end of the piezoelectric element 5 in the expanding and contracting direction by an adhesive. This driving shaft 6 is formed into a cylindrical shape by a graphite composite in which graphite crystals are compounded firmly, such as carbon graphite.

The weight 11 is attached to the other end of the piezoelectric element 5 in the expanding and contracting direction. This weight 11 prevents the other end side of the piezoelectric element 5 from being displaced by a greater degree than the one end side thereof by applying a load to the other end side of the piezoelectric element 5. The weight 11 should preferably be heavier than the driving shaft 6 in order to transmit the expansion and contraction of the piezoelectric element 5 efficiently to the driving shaft 6 side. It should be noted that if the piezoelectric element 5 is supported by, for example, fixing the other end side of the weight 11 to the holder 4, the elastic member 12 becomes unnecessary.

One end portion of the driving shaft 6 is passed through a bearing hole 41a formed in a partition portion 41 of the holder 4 in a clearance-fit manner. Meanwhile, the other end portion of the driving shaft 6 is passed through a bearing hole 42a formed in a partition portion 42 of the holder 4 in a clearance-fit manner. Consequently, the driving shaft 6 is reciprocatable along the expanding and contracting direction. It should be noted that an opening 4a is formed in the holder 4, and the opening 4a is covered by a detachable holder cover 13.

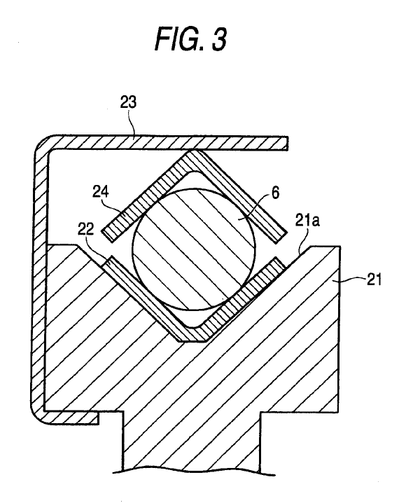

An engaging portion 21 of the lens frame 2, whose movement region is restricted to between the partition portions 41 and 42 by these partition portions, is frictionally engaged with the driving shaft 6. FIG. 3 is a cross-sectional view taken along line III-III of FIG. 1. As shown in FIG. 3, the driving shaft 6 is clamped by a plate member 22 having a V-shaped cross section and fixed in a V-groove 21a of the engaging portion 21 and a plate member 24 having a V-shaped cross section and urged toward the plate member 22 side by a leaf spring 23 retained by the engaging portion 21. Consequently, the engaging portion 21 during its movement produces a fixed frictional force with respect to the driving shaft 6.

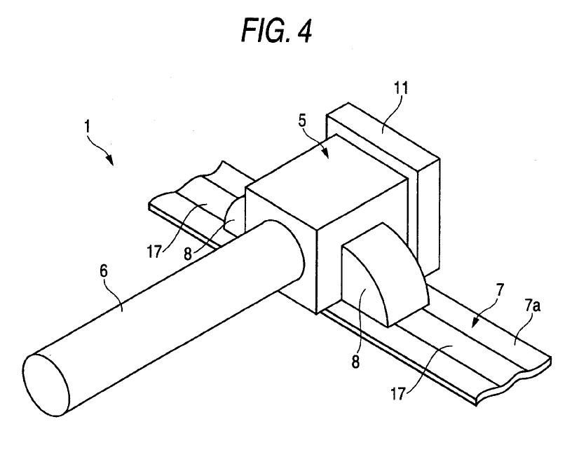

FIG. 4 is a perspective view of the piezoelectric element and its vicinities of the driving apparatus shown in FIG. 1. As shown in FIG. 4, the piezoelectric element 5 is electrically connected to the FPC 7 of a tape form, which extends in a substantially perpendicular direction to the expanding and contracting direction. The FPC 7 is electrically connected to a driving circuit (not shown) and transmits electrical signals for driving the piezoelectric element 5 from the driving circuit to the piezoelectric element 5.

The piezoelectric element 5 is fixed to a surface 7a of the FPC 7 by an electrically conductive adhesive 8 such that its expanding and contracting direction becomes substantially parallel to the surface 7a of the FPC 7. The electrically conductive adhesive 8 electrically connects a terminal of the piezoelectric element 5 and a wiring 17 provided on the surface 7a of the FPC 7. It should be noted that, as the electrically conductive adhesive 8, a thermosetting adhesive containing 70 wt. % silver particles and 20 wt. % epoxy resin.

In the driving apparatus 1 thus configured, electrical signals for driving the piezoelectric element 5 are transmitted from the driving circuit to the piezoelectric element 5, and the piezoelectric element 5 repeats expansion and contraction by the input of the electrical signals. The driving shaft 6 reciprocates in correspondence with this expansion and contraction. At this time, the an expansion speed and the contraction speed of the piezoelectric element 5 are made different, the speed at which the driving shaft 6 moves in one direction and the speed at which it moves in the other direction become different. Consequently, the engaging portion 21 and, hence, the lens frame 2 are moved in a desired direction.

As described above, in the driving apparatus 1, the piezoelectric element 5 is fixed to the surface 7a of the FPC 7 such that the expanding and contracting direction of the piezoelectric element 5 becomes substantially parallel to the surface 7a of the FPC 7, and the piezoelectric element 5 is electrically connected to the FPC 7. As a result, the thicknesswise direction of the FPC 7 (a direction substantially perpendicular to the surface 7a) coincides with the substantially perpendicular direction to the expanding and contracting direction of the piezoelectric element 5 (here, a direction which is also substantially perpendicular to the extending direction of the FPC 7), so that it is possible to attain a low profile of the driving apparatus 1 in that direction.

In addition, since the FPC 7 is used in the transmission of the electrical signals for driving the piezoelectric element 5, it is possible to enlarge the degree of freedom in the wiring layout. Further, since the electrically conductive adhesive 8, which has lower rigidity and higher elasticity than solder, is used in the electrical connection between the piezoelectric element 5 and the FPC 7, it is possible to prevent the expansion and contraction of the piezoelectric element 5 from being hampered due to the electrical connection to the FPC 7.

In addition, since the piezoelectric element 5 at its portion 5b opposite to the portion 5a having the FPC 7 mounted thereon is supported by the elastic member 12 from lateral directions with respect to the expanding and contracting direction, the vibration due to the expansion and contraction of the piezoelectric element 5 becomes difficult to be transmitted to the elastic member 12. As a result, the lens frame 2 can be reliably moved relative to the driving shaft 6 while preventing the effect of resonance accompanying the expansion and contraction of the piezoelectric element 5.

### Second Embodiment

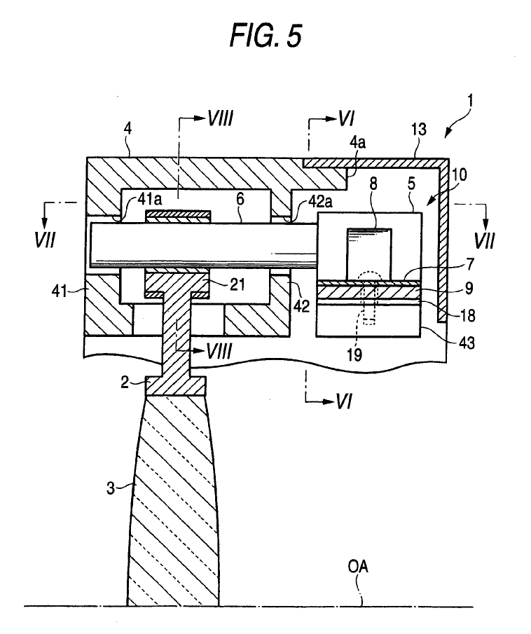

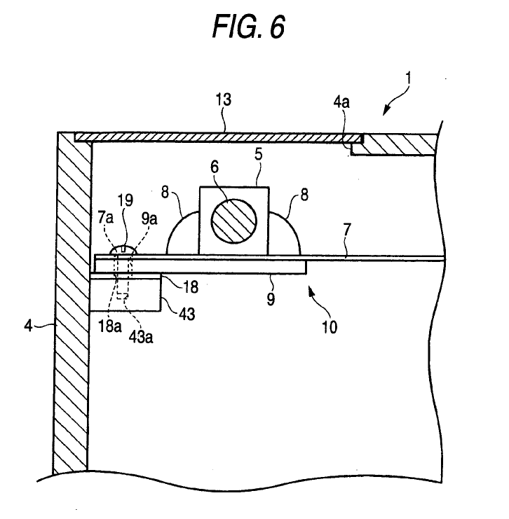

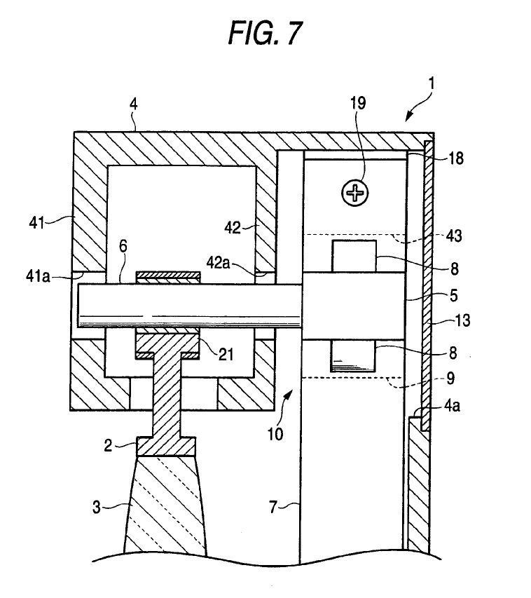

FIG. 5 is a cross-sectional view of a second embodiment of the driving apparatus in accordance with the invention. FIG. 6 is a cross-sectional view taken along line VI-VI of FIG. 5, and FIG. 7 is a cross-sectional view taken along line VII-VII of FIG. 5. As shown in FIGS. 5 to 7, the driving apparatus 1 is an apparatus for driving the lens 3, which is held by the lens frame (driven body) 2, along the optical axis OA, and is suitable for use in a cellular telephone with a camera, a compact digital camera, or the like.

The driving apparatus 1 has the holder (support) 4 for accommodating the lens frame 2. The holder 4 supports the piezoelectric element (electromechanical conversion element) 5 which expands and contracts along the expanding and contracting direction parallel to the optical axis OA (hereafter, this direction will be simply referred to as the “expanding and contracting direction”). The driving shaft (driving member) 6 is fixed to one end of the piezoelectric element 5 in the expanding and contracting direction by an adhesive so as to extend in the expanding and contracting direction. The driving shaft 6 is formed into a cylindrical shape by a graphite composite in which graphite crystals are compounded firmly, such as carbon graphite. It should be noted that the opening 4a is formed in the holder 4, and the opening 4a is covered by the detachable holder cover 13.

One end portion of the driving shaft 6 is passed through the bearing hole 41a formed in the partition portion 41 of the holder 4 in a clearance-fit manner. Meanwhile, the other end portion of the driving shaft 6 is passed through the bearing hole 42a formed in the partition portion 42 of the holder 4 in a clearance-fit manner. Consequently, the driving shaft 6 is reciprocatable along the expanding and contracting direction.

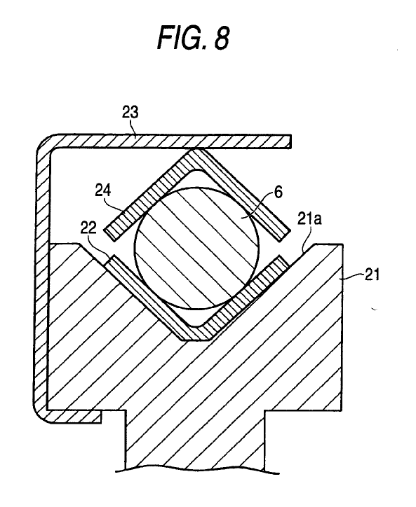

The engaging portion 21 of the lens frame 2, whose movement region is restricted to between the partition portions 41 and 42 by these partition portions, is frictionally engaged with the driving shaft 6. FIG. 8 is a cross-sectional view taken along line VIII-VIII of FIG. 5. As shown in FIG. 8, the driving shaft 6 is clamped by the plate member 22 having a V-shaped cross section and fixed in the V-groove 21a formed in the engaging portion 21 and the plate member 24 having a V-shaped cross section and urged toward the plate member 22 side by the leaf spring 23 retained by the engaging portion 21. Consequently, the engaging portion 21 during its movement produces a fixed frictional force with respect to the driving shaft 6.

Here, a description will be given of the structure of supporting the piezoelectric element 5 by the holder 4.

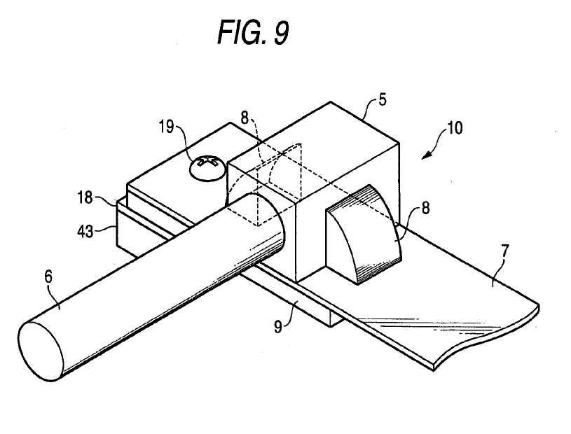

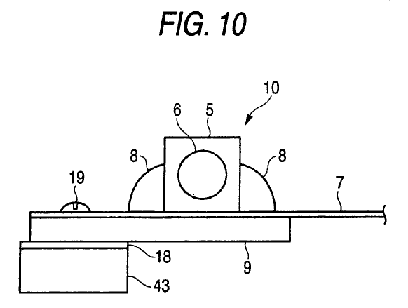

FIG. 9 is a perspective view of the piezoelectric element and its vicinities of the driving apparatus shown in FIG. 5. FIG. 10 is a front elevational view of the piezoelectric element and its vicinities of the driving apparatus shown in FIG. 5. As shown in FIGS. 9 and 10, the piezoelectric element 5 is electrically connected by the electrically conductive adhesive 8 to the surface of the flexible printed circuit board (FPC) 7 of the tape form which extends in the substantially perpendicular direction to the expanding and contracting direction. To improve the shock resistance, the electrically conductive adhesive 8 should preferably be elastic.

The FPC 7 at its distal end side is electrically connected to the driving circuit (not shown) and transmits electrical signals for driving the piezoelectric element 5 from the driving circuit to the piezoelectric element 5. A rectangular plate-shaped reinforcing plate (reinforcing member) 9, which is formed of such as a metal or polyimide, is fixed to a reverse surface of a proximal end portion of the FPC 7 by an adhesive. The reinforcing plate 9 has an outer shape which, when viewed from a substantially perpendicular direction to the surface of the FPC 7, includes a connecting portion between the piezoelectric element 5 and the FPC 7 (i.e., a portion where the electrically conductive adhesive 8 is disposed). A piezoelectric element unit 10 is constituted by the piezoelectric element 5, the driving shaft 6, the FPC 7, the electrically conductive adhesive 8, and the reinforcing plate 9.

The piezoelectric element unit 10 is fixed to a shelf portion 43 of the holder 4 by a bolt 19 through an elastic member 18 formed of silicone, for example. Namely, the FPC 7 is fixed to the holder 4 by means of the reinforcing plate 9. Thus, the holder 4 supports the piezoelectric element 5 as the FPC 7 is fixed to the holder 4 by means of the reinforcing plate 9. It should be noted that, as shown in FIG. 6, the through hole 7a and a through hole 9a, each having an inside diameter greater than the outside diameter of a threaded portion of the bolt 19, are respectively formed in the FPC 7 and the reinforcing plate 9 in a continuous manner. The threaded portion of the bolt 19 is threadedly engaged with a threaded hole 43a formed in the shelf portion 43 of the holder 4 through the through holes 7a and 9a and a through hole 18a formed in the elastic member 18.

As described above, in the driving apparatus 1, the FPC 7, to which the piezoelectric element 5 is electrically connected by the electrically conductive adhesive 8, is used for the transmission of the electrical signals for driving the piezoelectric element 5. For this reason, the thicknesswise direction of the FPC 7 can be made to coincide with the substantially perpendicular direction to the expanding and contracting direction of the piezoelectric element 5, thereby making it possible to lower the profile of the driving apparatus 1 in that direction. Furthermore, since the FPC 7 is fixed to the holder 4 by means of the reinforcing plate 9, the holder 4 supports the piezoelectric element 5. Consequently, at the time of the assembly of the driving apparatus 1 when the FPC 7 is fixed to the holder 4 by means of the reinforcing plate 9, and the forming of the FPC 7 is effected to electrically connect the FPC 7 at its distal end side to the driving circuit, since the piezoelectric element 5 is not directly fixed to the holder 4, the concentration of stress at the connecting portion between the piezoelectric element 5 and the FPC 7 is avoided. Hence, according to the driving apparatus 1, it is possible to reliably transmit the electrical signals to the piezoelectric element 5 through the FPC 7.

In addition, in the driving apparatus 1, the FPC 7 is used for the transmission of the electrical signals for driving the piezoelectric element 5. As a result, it is possible to enlarge the degree of freedom in the wiring layout for electrically connecting the FPC 7 at its distal end side to the driving circuit. Moreover, the FPC 7 is fixed to the holder 4 by means of the reinforcing plate 9 which has an outer shape which, when viewed from the substantially perpendicular direction to the surface of the FPC 7, includes the connecting portion between the piezoelectric element 5 and the FPC 7. For this reason, at the time of the assembly of the driving apparatus 1, when the piezoelectric element unit 10 is fitted in the holder 4, it is possible to prevent the FPC 7 from becoming deformed to damage the connecting portion between the piezoelectric element 5 and the FPC 7.

In addition, in the driving apparatus 1, the piezoelectric element unit 10 is fixed to the holder 4 by the bolt 19. As a result, when the piezoelectric element 5 has failed, the holder cover 13 is removed from the holder 4, and the piezoelectric element unit 10 can be easily replaced through the opening 4a of the holder 4.

In addition, in the driving apparatus 1, the through hole 7a and the through hole 9a, each having an inside diameter greater than the outside diameter of the threaded portion of the bolt 19, are respectively formed in the FPC 7 and the reinforcing plate 9 in a continuous manner. Further, the piezoelectric element unit 10 is fixed to the holder 4 by means of the elastic member 18. Consequently, even if, for example, there is a variation in the mounting angle of the driving shaft 6 in the piezoelectric element unit 10, when the piezoelectric element unit 10 is fixed to the holder 4 by the bolt 19, it is possible to prevent the driving shaft 6 from being excessively restrained by the bearing hole 41a of the partition portion 41 and the bearing hole 42a of the partition portion 42.

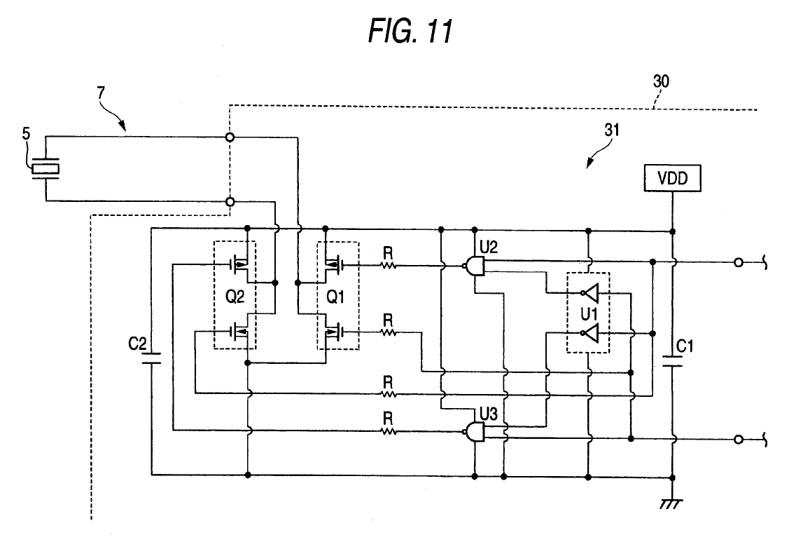

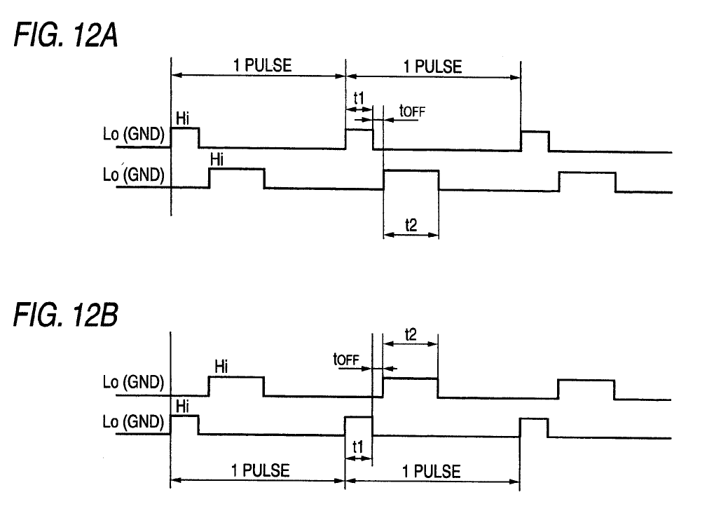

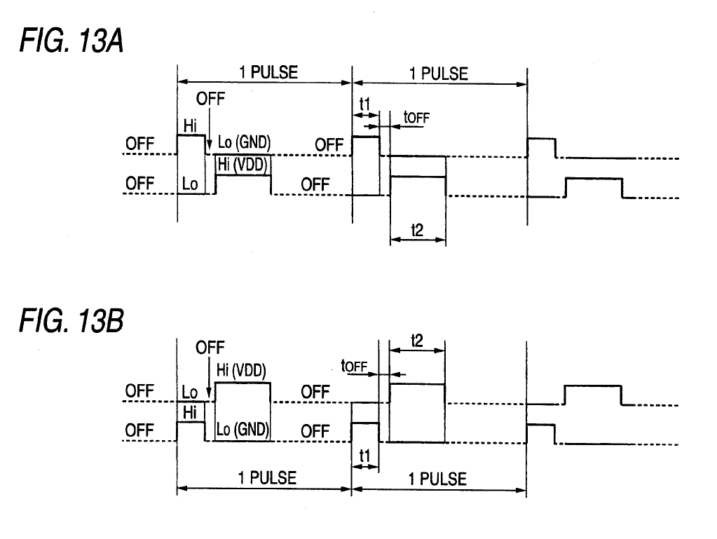

Next, a description will be given of the operation of the driving apparatus 1. FIG. 11 is a circuit diagram of the driving circuit for operating the piezoelectric element of the driving apparatus shown in FIG. 5. FIGS. 12A and 12B are waveform diagrams of input signals which are inputted to the driving circuit shown in FIG. 11, and FIGS. 13A and 13B are waveform diagrams of output signals which are outputted from the driving circuit shown in FIG. 11.

As shown in FIG. 11, a driving circuit 31 is provided in a control unit 30. The control unit 30 effects overall control of the driving apparatus 1, and has, for example, a CPU, a ROM, a RAM, an input signal circuit, an output signal circuit, and the like. The driving circuit 31 functions as a drive circuit for the piezoelectric element 5, and outputs driving electrical signals to the piezoelectric element 5. A control signal from a control-signal-generating portion of the control unit 30 is inputted to the driving circuit 31, and the driving circuit 31 outputs a driving electrical signal for the piezoelectric element 5 by effecting the voltage amplification or current amplification of that control signal. As the driving circuit 31, a driving circuit is used in which, for example, its input stage is constituted by logical circuits U1 to U3, and field-effect type transistors (FETs) Q1 and Q2 are provided in its output stage. In terms of their output signals, the transistors Q1 and Q2 are capable of outputting a Hi output (high-potential output), a Lo output (low-potential output), and an OFF output (open output).

FIG. 12A shows an input signal which is inputted when moving the lens frame 2 so that the engaging portion 21 approaches the piezoelectric element 5, and FIG. 12B shows an input signal which is inputted when moving the lens frame 2 so that the engaging portion 21 moves away from the piezoelectric element 5. In addition, FIG. 13A shows an output signal which is outputted when moving the lens frame 2 so that the engaging portion 21 approaches the piezoelectric element 5, and FIG. 13B shows an output signal which is outputted when moving the lens frame 2 so that the engaging portion 21 moves away from the piezoelectric element 5.

Output signals in FIGS. 13A and 13B are pulse signals which are turned on and off at the same timing as the input signals in FIGS. 12A and 12B. The two signals in FIGS. 13A and 13B are inputted to the piezoelectric element 5 through the FPC 7. A pulse signal having a sawtooth waveform may be inputted to the piezoelectric element 5, but the piezoelectric element 5 can also be operated even if a pulse signal having a rectangular waveform is inputted thereto, as shown in FIGS. 13A and 13B. In this case, since the driving signal for the piezoelectric element 5 can be a pulse signal having a rectangular waveform, the signal generation is facilitated.

The output signals in FIGS. 13A and 13B are constituted by two pulse signals which are at the same frequency. As the phases of these two pulse signals are made mutually different, these two pulse signals are respectively formed into signals in which the potential difference between the two signals becomes large in steps and then becomes suddenly small or signals in which the potential difference between the two signals becomes suddenly large and then becomes small in steps. By inputting such two signals, the expansion speed and the contraction speed of the piezoelectric element 5 can be made different, and it becomes possible to move the engaging portion 21 and, hence, the lens frame 2.

For instance, in FIGS. 13A and 13B, the setting provided is such that after one signal has been set from Hi to Lo, the other signal is set to Hi. In these signals, the setting provided is such that when the one signal has been set to Lo, the other signal is set to Hi after the lapse of a fixed time lag T_{OFF}. In addition, when the two signals are both at Lo, their outputs are in an OFF state (open state).

As output signals of FIGS. 13A and 13B, i.e., electrical signals for operating the piezoelectric element 5, signals of frequencies exceeding an audio frequency are used. In FIGS. 13A and 13B, the two signals are set as frequency signals exceeding an audio frequency, and frequency signals of 30 to 80 kHz, more preferably 40 to 60 kHz, are used. As the signals of such frequencies are used, it is possible to reduce the operational noise of the piezoelectric element 5 in the audible region.

Through the above, the driving apparatus 1 operates as follows. Namely, electrical signals are inputted to the piezoelectric element 5, and the piezoelectric element 5 repeats expansion and contraction by the input of the electrical signals. The driving shaft 6 reciprocates in correspondence with the expansion and contraction. At this time, as the expansion speed and the contraction speed of the piezoelectric element 5 are made different, the speed at which the driving shaft 6 moves in one direction and the speed at which it moves in the other direction become different. As a result, the engaging portion 21 and, hence, the lens frame 2 are moved in the desired direction.

The invention is not limited to the above-described embodiments.

For example, in the above-described first embodiment, instead of the FPC 7, a so-called rigid substrate may be used for the transmission of electrical signals for driving the piezoelectric element 5. Further, solder may be used in the electrical connection between the piezoelectric element 5 and the FPC 7 or the rigid board.

In addition, although the case of the above-described first embodiment is the case in which the driving apparatus 1 drives the lens frame 2, the driving apparatus may be adapted to dive a driven body other than the lens frame 2.

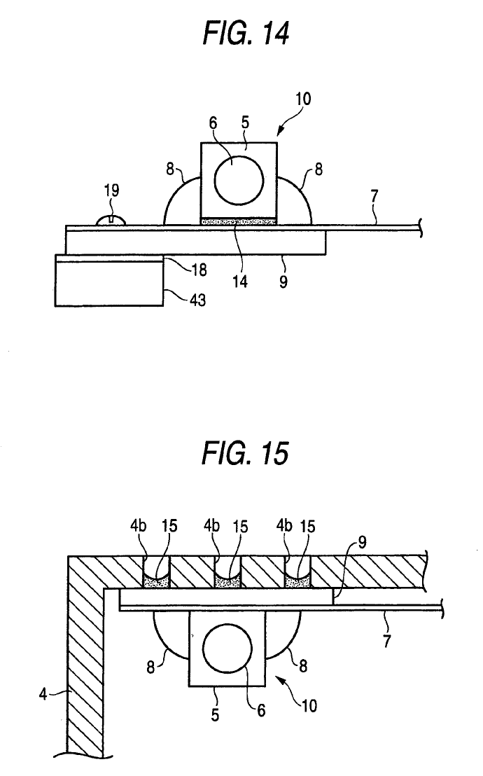

In addition, in the above-described second embodiment, the piezoelectric element 5 may be electrically connected to the surface of the FPC 7 by the electrically conductive adhesive 8 by interposing an elastic member 14 formed of such as silicone between the piezoelectric element 5 and the FPC 7, as shown in FIG. 14. In this case, it is possible to reliably transmit the vibration of the piezoelectric element 5 to the driving shaft 6 by preventing the resonance with other parts.

In addition, in the above-described second embodiment, the fixation of the piezoelectric element unit 10 to the holder 4 is not limited to the fixation by the bolt 19, and may be fixation by an adhesive. As shown in FIG. 15 by way of an example, the piezoelectric element unit 10 may be fixed to the holder 4 by filling an adhesive 15 into a plurality of through holes 4b formed in a wall portion of the holder 4 in a state in which the reinforcing plate 9 of the piezoelectric element unit 10 abuts against an inner surface of the wall portion of the holder 4.

In addition, although the case of the above-described second embodiment is the case in which the printed circuit board is the FPC 7, the printed circuit board may be a so-called rigid board. In the case where the printed circuit board is the rigid plate, the reinforcing plate 9 is not essential.

In addition, although the case of the above-described second embodiment is the case in which the driving apparatus 1 drives the lens frame 2, the driving apparatus may be adapted to drive a driven body other than the lens frame 2.

According to the invention, it is possible to lower the profile of the driving apparatus in the substantially perpendicular direction to the expanding and contracting direction of the electromechanical conversion element.

The entire disclosure of each and every foreign patent application from which the benefit of foreign priority has been claimed in the present application is incorporated herein by reference, as if fully set forth.

What is claimed is:

1. A driving apparatus comprising:
an electromechanical conversion element that expands or contracts along an expanding and contracting direction;
a driving member attached to one end of the electromechanical conversion element in the expanding and contracting direction;
a driven body frictionally engaged with the driving member; and
a printed circuit board that transmits an electrical signal for driving the electromechanical conversion element,
wherein the electromechanical conversion element is mounted on a surface of the printed circuit board such that the expanding and contracting direction becomes substantially parallel to the surface of the printed circuit board, and the electromechanical conversion element is electrically connected to the printed circuit board.

2. The driving apparatus according to claim 1,
wherein, in a portion where the electromechanical conversion element is mounted, the printed circuit board in the expanding and contracting direction has a length equal to or shorter than that of the electromechanical conversion element in the expanding and contracting direction.

3. The driving apparatus according to claim 1,
wherein the printed circuit board is a flexible printed circuit board.

4. The driving apparatus according to claim 1,
wherein the electromechanical conversion element is electrically connected to the printed circuit board by an electrically conductive adhesive.

5. The driving apparatus according to claim 1,
wherein the electromechanical conversion element is supported, at its portion opposite to its portion where the printed circuit board is mounted, by an elastic member from a lateral direction with respect to the expanding and contracting direction.

6. A driving apparatus comprising:
an electromechanical conversion element that expands or contracts along an expanding and contracting direction;
a driving member attached to one end of the electromechanical conversion element in the expanding and contracting direction;
a driven body frictionally engaged with the driving member; and
a printed circuit board to which the electromechanical conversion element is electrically connected by an electrically conductive adhesive, and which transmits an electrical signal for driving the electromechanical conversion element; and
a support that supports the electromechanical conversion element,
wherein the printed circuit board is fixed to the support so that the support supports the electromechanical conversion element.

7. The driving apparatus according to claim 6,
wherein the printed circuit board is a flexible printed circuit board and is fixed to the support by means of a reinforcing member.
